(19) United States
(12) Patent Application Publication
(10) Pub. No.: US 2026/0326449 A1
(43) Pub. Date: Oct. 22, 2026

(54) LIQUID EJECTION DEVICE, AND INKJET RECORDING APPARATUS

(71) Applicant: KYOCERA Document Solutions Inc., Osaka-shi, Osaka (JP)

(72) Inventors: Shogo Yoneda, Osaka (JP); Kenichi Satake, Osaka (JP); Hideki Ishida, Osaka (JP); Nanako Nishida, Osaka (JP); Shun Tsuboi, Osaka (JP); Koichi Imanaka, Osaka (JP)

(21) Appl. No.: 19/647,156

(22) Filed: Apr. 14, 2026

(30) Foreign Application Priority Data
Apr. 17, 2025 (JP) 2025-067922

(51) Int. Cl. B41J 2/175

(52) U.S. Cl. CPC B41J 2/17523; B41J 2/17596; B41J 2202/05

(57) ABSTRACT

A supply path forming the flow path of a liquid supplied from a liquid storage portion to a liquid ejection head includes a first supply path and a second supply path. The first supply path includes a coiled tube that is elastically deformable, and is connected to the movable liquid ejection head. The second supply path includes a base member made of synthetic resin that forms a groove through which the liquid flows and a joining flow path having a film joined to the base member in a state that blocks an opening of the groove, and is connected to the liquid storage portion and the first supply path.

### INCORPORATION BY REFERENCE

This application is based upon and claims the benefit of priority from the corresponding Japanese Patent Application No. 2025-067922 filed on Apr. 17, 2025, the entire contents of which are incorporated herein by reference.

### BACKGROUND

The present disclosure relates to a liquid ejection device and an inkjet recording apparatus that are provided with a movable head unit including a liquid ejection head and a supply path through which liquid flows to be supplied to the liquid ejection unit.

An inkjet recording apparatus includes an ink ejection device that ejects ink droplets onto a sheet from each of a plurality of nozzles of an inkjet head, thereby forming an image on the sheet. The ink ejection device is an example of a liquid ejection device that ejects droplets. The inkjet head is an example of a liquid ejection head.

In the liquid ejection device, a liquid supply device supplies liquid from a liquid storage portion to the liquid ejection head. The liquid supply device includes a supply path connected to the liquid storage portion and the liquid ejection head.

Air bubbles may be generated in the supply path. When the air bubbles flow into the liquid ejection head together with the liquid, the liquid ejection head may fail to eject the liquid droplets.

In addition, in a case in which a pressure regulation valve device is arranged in the supply path, the air bubbles may cause the pressure regulation valve device to malfunction.

For example, an inkjet recording apparatus that includes a degassing module and a circulation device that returns the ink in an ink tank to the liquid storage portion via the degassing module is known. The ink tank is an example of the liquid storage portion.

### SUMMARY

A liquid ejection device according to one aspect of the present disclosure includes a head unit and a supply path. The head unit has a liquid ejection head that ejects liquid droplets from each of a plurality of nozzles, and is supported so as to be movable. The supply path is connected to a liquid storage portion that stores liquid and the liquid ejection head, and the supply path that forms a flow path for the liquid supplied from the liquid storage portion to the liquid ejection head includes a first supply path and a second supply path. The first supply path includes a coiled tube that is formed in a coil shape and is elastically deformable and is connected to the liquid ejection head. The second supply path includes a base member made of synthetic resin that forms a groove through which the liquid flows and a joining flow path having a film joined to the base member in a state that blocks an opening of the groove, and is connected to the liquid storage portion and the first supply path.

According to another aspect of the present disclosure, there is provided an inkjet recording apparatus including a sheet conveying device that conveys a sheet, and the liquid ejection device that forms an image on the sheet by ejecting ink droplets onto the sheet being conveyed.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram showing a configuration of an inkjet recording apparatus according to an embodiment.

FIG. 2 is a diagram showing a configuration of an ink supply device and an inkjet head in an inkjet recording apparatus according to an embodiment.

FIG. 3 is a perspective view of a part of a joining flow path in an inkjet recording apparatus according to an embodiment.

FIG. 4 is a perspective view of another part of a joining flow path in an inkjet recording apparatus according to an embodiment.

### DETAILED DESCRIPTION

Hereinafter, embodiments according to the present disclosure will be described with reference to the drawings. Note that the following embodiments are examples of a specific embodiment according the present disclosure, and do not limit the technical scope of the present disclosure.

### Configuration of Inkjet Recording Apparatus 10

An inkjet recording apparatus 10 according to an embodiment is an image forming apparatus capable of executing a printing process by an inkjet method. The printing process is a process in which an image is formed on a sheet 9. The sheet 9 is a sheet-like image forming medium such as paper or a resin film.

The inkjet recording apparatus 10 may be a facsimile apparatus, a copier, a multifunction peripheral, or the like that can perform the printing process using an inkjet method.

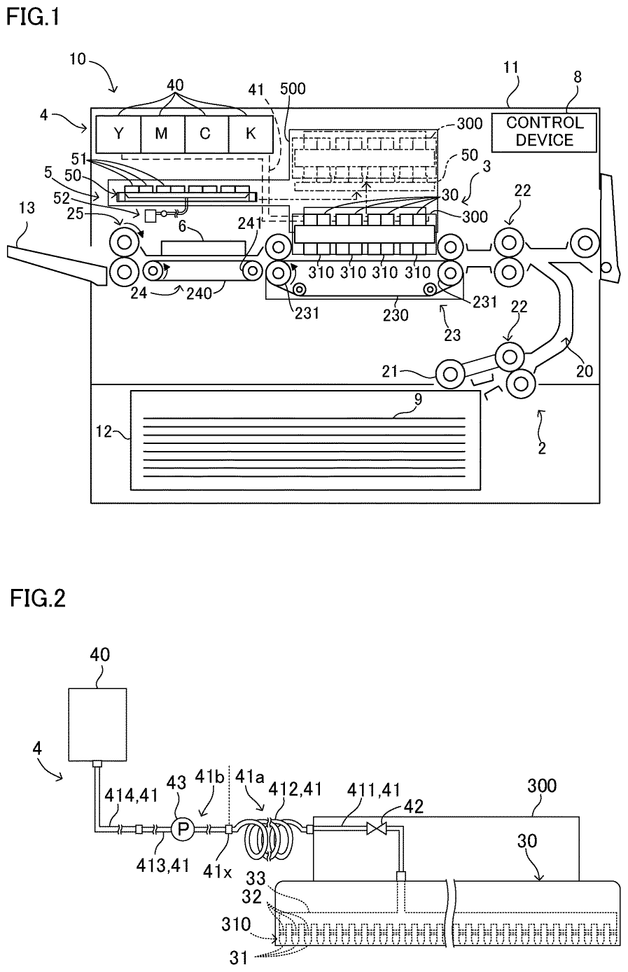

As shown in FIG. 1, the inkjet recording apparatus 10 includes a sheet storing portion 12, a sheet conveying device 2, an ink ejecting device 3, a drying device 6, a control device 8, and the like. The sheet conveying device 2, the ink ejecting device 3, the drying device 6, and the control device 8 are housed in a housing 11 that forms a main body.

The ink ejecting device 3 includes an ink supply device 4, a plurality of inkjet heads 30 and an ink discharging device 5. The ink supply device 4 supplies ink to the plurality of inkjet heads 30.

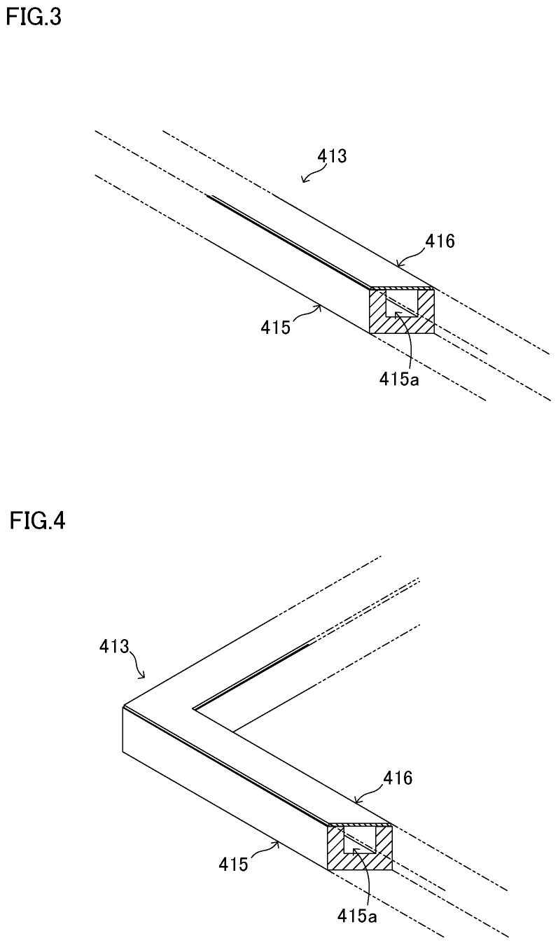

Each inkjet head 30 has a nozzle group 310 including a plurality of nozzles 31 (see FIGS. 1 and 3). Each of the plurality of nozzles 31 ejects ink droplets. The ink discharging device 5 executes an ink discharging process that discharges ink from the plurality of inkjet heads 30.

The sheet storing portion 12 can store a plurality of sheets 9. The sheet conveying device 2 conveys each of the sheets 9 stored in the sheet storing portion 12 along a sheet conveying path 20, and then discharges the sheets 9 from the sheet conveying path 20 onto a discharge tray 13.

The sheet conveying device 2 includes a sheet feeding mechanism 21, a plurality of sets of conveying roller pairs 22, a main conveying unit 23, a subsequent conveying unit 24, a discharge roller pair 25, and the like. The sheet feeding mechanism 21 feeds each sheet 9 from the sheet storing portion 12 to the sheet conveying path 20.

The plurality of sets of conveying roller pairs 22 take over the conveying of the sheet 9 from the sheet feeding mechanism 21 and convey the sheet 9 toward the main conveying unit 23.

The main conveying unit 23 is arranged below the plurality of inkjet heads 30. The main conveying unit 23 conveys each sheet 9 along the nozzle group 310 of the plurality of inkjet heads 30.

In the main conveying unit 23, a plurality of tension rollers 231 support and rotate a continuous main conveying belt 230. Thus, the main conveying unit 23 places each sheet 9 on an upper surface of the main conveying belt 230 and conveys each sheet 9, then feeds each sheet 9 out to the subsequent conveying unit 24. An area between the upper surface of the main conveying belt 230 and the plurality inkjet heads 30 forms part of the sheet conveying path 20.

The subsequent conveying unit 24 is arranged on a downstream side in a sheet conveying direction relative to the main conveying unit 23 positioned at the reference position.

In the subsequent conveying unit 24, a plurality of tension rollers 241 support and rotate a continuous subsequent conveying belt 240. Thus, the subsequent conveying unit 24 places each sheet 9 on which an image has been formed on an upper surface of the subsequent conveying belt 240 and conveys each sheet 9, and then feeds each sheet 9 out to the discharge roller pair 25.

The drying device 6 dries the ink on each sheet 9 by blowing hot air onto each sheet 9 conveyed by the subsequent conveying unit 24. The discharge roller pair 25 discharges each of the sheets 9 on which an image has been formed onto the discharge tray 13.

The ink supply device 4 includes a plurality of ink containers 40 and a plurality of supply paths 41 (see FIGS. 1 and 2). Each ink container 40 stores ink. Each supply path 41 is connected to each ink container 40 and each inkjet head 30.

Each of the plurality of ink containers 40 stores ink of a different color. Each of the plurality of inkjet heads 30 ejects ink of a different color. In the present embodiment, the ink colors include four colors: black, cyan, magenta, and yellow.

Each ink container 40 is an example of a liquid storage portion that stores liquid. Ink is an example of a liquid.

The ink supply device 4 supplies ink from each ink container 40 to each inkjet head 30 via each supply path 41. Each supply path 41 forms a flow path for the ink to be supplied from each ink container 40 to each inkjet head 30.

Each inkjet head 30 executes an ink ejecting process of ejecting ink droplets from each of the plurality of nozzles 31. The plurality of inkjet heads 30 eject ink droplets onto each sheet 9 conveyed by the main conveying unit 23 to form an image on each sheet 9.

The ink ejecting process is an example of a liquid ejecting process in which droplets are ejected. Each of the inkjet heads 30 is an example of a liquid ejection head that executes the liquid ejecting process. The ink ejecting device 3 is an example of a liquid ejecting device equipped with the liquid ejection head.

The ink discharging process is an example of a liquid discharging process for discharging the liquid inside the liquid ejection heads. The ink discharging device 5 is an example of a liquid discharging device that executes the liquid discharging process.

The control device 8 controls the sheet conveying device 2, the ink ejecting device 3 and the drying device 6.

The control device 8, by controlling the sheet conveying device 2, controls the conveying of each sheet 9. Furthermore, the control device 8 causes the plurality of inkjet heads 30 to execute the ink ejecting process in synchronization with the conveying of the sheet 9.

Moreover, the control device 8 controls the ink discharging device 5 to cause the ink discharging device 5 to execute the ink discharging process.

Each inkjet head 30 has an introduction path 33 that communicates with the plurality of nozzles 31 (see FIG. 3). The ink supplied by the ink supply device 4 is supplied to the plurality of nozzles 31 via the introduction path 33.

Furthermore, each inkjet head 30 has a plurality of piezoelectric elements 32 corresponding to the plurality of nozzles 31 (see FIG. 3). Each piezoelectric element 32 vibrates when a discharge drive signal is supplied from the control device 8. Each piezoelectric element 32 vibrates to pressurize the ink, causing the ink to be ejected from each nozzle 31.

Air bubbles may occur in the supply path 41. When air bubbles flow into each inkjet head 30 together with the ink, ink droplet ejection failure may occur in each inkjet head 30.

The ink ejecting device 3 includes an ink discharging device 5 for discharging the air bubbles from each inkjet head 30 together with the ink.

The ink discharging device 5 has a cap 51 capable of covering the nozzle group 310 of the plurality of inkjet heads 30 (see FIGS. 2 and 3). The ink discharging device 5 further includes a suction device 52 for sucking air from within the cap 51 covering the nozzle group 310 (see FIGS. 2 and 3).

The ink discharging process is a process of discharging the ink from each of the plurality of inkjet heads 30 via the cap 51 by suctioning the air from inside the cap 51.

By executing the ink discharging process, the air bubbles inside each inkjet head 30 are discharged together with the ink. Furthermore, at the same time that the ink in each inkjet head 30 is discharged, new ink is supplied to each inkjet head 30 by the ink supply device 4.

In the ink ejecting device 3, a plurality of inkjet heads 30 are movably supported. More specifically, the ink discharging device 5 moves the head unit 300 including the plurality of inkjet heads 30. The ink discharging device 5 is an example of a capping mechanism that covers the plurality of nozzles 31 of the inkjet head 30 with the cap 51.

More specifically, the ink discharging device 5 includes a unit moving device 500 (see FIG. 1). As will be described later, the unit moving device 500 moves the head unit 300 from the reference position to a head retreat position, and then moves the cap unit 50 including the cap 51 to a cap position that covers the plurality of nozzles 31.

### Configuration of Ink Discharging Device 5

The ink discharging device 5 includes the cap unit 50 and the unit moving device 500 (see FIG. 1).

The cap unit 50 includes a cap 51 and part or all of a suction device 52, and is movably supported. In the present embodiment, the head unit 300 including the plurality of inkjet heads 30 is also movably supported. The unit moving device 500 moves the cap unit 50 and the head unit 300.

The head unit 300 is supported so as to be movable between the reference position and the head retreat position. The reference position is the position of the head unit 300 when the nozzle group 310 is arranged along the main conveying belt 230.

The head retreat position is a position farther from the main conveying belt 230 than the reference position. For example, the head retreat position is a position vertically above the reference position.

The cap unit 50 is supported so as to be movable between a cap retreat position and a cap position. The cap retreat position is a position where the cap unit 50 does not interfere with the head unit 300. The cap position is a position of the cap unit 50 when the cap 51 covers the nozzle group 310 of the plurality of inkjet heads 30.

In FIG. 1, the head unit 300 positioned at the reference position is indicated by a solid line, and the head unit 300 positioned at the head retreat position is indicated by a two-dot chain line. Similarly, the cap unit 50 positioned at the cap retreat position is indicated by a solid line, and the cap unit 50 positioned at the cap position is indicated by a two-dot chain line.

The unit moving device 500 moves the head unit 300 from the reference position to the head retreat position, and further moves the cap unit 50 from the cap retreat position to the cap position, in accordance with a first movement control by the control device 8.

When the cap unit 50 is in the cap position, the suction device 52 is activated. Thus, ink inside each inkjet head 30 is discharged together with the air bubbles, and new ink that does not include air bubbles is supplied from the ink supply device 4 into each inkjet head 30.

The unit moving device 500 moves the cap unit 50 from the cap position to the cap retreat position in accordance with a second movement control by the control device 8, and further moves the head unit 300 from the head retreat position to the reference position.

When the head unit 300 is supported so as to be movable, it is desirable that each supply path 41 can be arranged compactly.

On the other hand, it is desirable to be able to suppress generation of air bubbles in each of the supply paths 41.

The ink supply device 4 of the ink ejecting device 3 has a configuration for achieving a compact arrangement of each supply path 41 and suppressing generation of air bubbles in each supply path 41.

### Configuration of Ink Supply Device 4

The ink supply device 4 includes a supply path 41 and a pressure regulation valve device 42 (see FIG. 2). The supply path 41 is a flow path that is connected to each ink container 40 and each inkjet head 30. The pressure regulation valve device 42 is arranged in the supply path 41.

The pressure regulation valve device 42 temporarily switches from a supply path closed state to a supply path open state in response to a pressure change that occurs in the supply path 41 due to the ejection of ink droplets from each inkjet head 30. The supply path closed state is a state in which the supply path 41 is blocked.

On the other hand, the supply path open state is a state in which the supply path 41 is unblocked. When the pressure regulation valve device 42 is switched to the supply path open state, ink is replenished into each inkjet head 30 in accordance with the ejection of ink droplets from each inkjet head 30.

When the pressure regulation valve device 42 is in the supply path open state, ink is supplied to each inkjet head 30 from each ink container 40 via the supply path 41.

The pressure regulation valve device 42 includes a diaphragm and a valve member. The diaphragm expands and contracts in response to changes in pressure within the pressure regulation valve device 42. The valve member moves between the closed position where the valve member blocks the flow path in the pressure regulation valve device 42 and an open position where the valve member unblocks the flow path in response to expansion and contraction of the diaphragm.

The state in which the valve member is in the closed position is the supply path closed state, and the state in which the valve member is in the open position is the supply path open state.

The ink supply device 4 further includes a pressure pump 43 arranged in the supply path 41 (see FIG. 2). The pressure pump 43 pressurizes the ink in the supply path 41. The control device 8 operates the pressure pump 43 when the printing process and the ink discharging process are executed.

### Configuration of Supply Path 41

The supply path 41 includes a first supply path 41a on an inkjet head 30 side relative to a relay portion 41x, and a second supply path 41b on an ink container 40 side relative to the relay portion 41x (see FIG. 2). The relay portion 41x is a part of the supply path 41.

The first supply path 41a includes a coiled tube 412 and is connected to the inkjet head 30. In the present embodiment, the first supply path 41a includes a coiled tube 412 connected to the relay portion 41x, and a head connection path 411 connected to one end of the coiled tube 412 and the inkjet head 30.

The pressure regulation valve device 42 is arranged in the head connection path 411. That is, the pressure regulation valve device 42 is arranged between a coiled tube 412 and the inkjet head 30 in the first supply path 41a.

The pressure regulation valve device 42 changes from a state in which the head connection path 411 is blocked to a state in which the head connection path 411 is unblocked in response to a change in pressure within the inkjet head 30 when the inkjet head 30 ejects ink droplets.

The head connection path 411 and the pressure regulation valve device 42 are included in the head unit 300. That is, the pressure regulation valve device 42 and the head connection path 411 move together with the inkjet head 30 when the inkjet head 30 moves.

The coiled tube 412 is a tube formed in a coil shape and capable of elastic deformation. For example, the coiled tube 412 is a tube made of synthetic resin whose main component is polypropylene or polyethylene terephthalate.

On the other hand, the head connection path 411 is a synthetic resin member or the like having a tube or other through-hole formed therein. For example, the head connection path 411 is a tube made of synthetic resin whose main component is polypropylene or polyethylene terephthalate.

On the other hand, the second supply path 41b includes a joining flow path 413 and is connected to the ink container 40 and the first supply path 41a. As shown in FIGS. 3 and 4, the joining flow path 413 includes a base member 415 and a film 416 joined to the base member 415.

The base member 415 is made of synthetic resin and forms a groove 415a through which ink flows. The film 416 is joined to the base member 415 in a state where the film 416 closes the opening of the groove 415a in the base member 415. For example, the film 416 is joined to the base member 415 by heat welding or adhesive.

An example of the base member 415 is a molded member made of synthetic resin whose main component is polypropylene or polyethylene terephthalate.

On the other hand, an example of the film 416 is a laminated film in which a plurality of films made of different materials are laminated. More specifically, it is conceivable that a laminate film including a layer of polypropylene film and a layer of polyethylene terephthalate film may be employed as the film 416.

The joining flow path 413 is fixed along a predetermined path. For example, the joining flow path 413 includes a right-angle bending portion. In this case, the joining flow path 413 is arranged along a path that includes a straight path and a bent path (see FIGS. 3 and 4).

FIG. 3 shows a straight portion of the joining flow path 413. FIG. 4 shows a bent portion of the joining flow path 413.

In the present embodiment, the second supply path 41b includes the joining flow path 413 and a container connecting path 414. The container connecting path 414 is a tube or other synthetic resin member having a through hole formed therein. For example, the container connecting path 414 is a tube made of synthetic resin whose main component is polypropylene or polyethylene terephthalate.

It is easy to form the joining flow path 413 in a shape that follows the intended path without any waste. By employing the joining flow path 413, the supply path 41 can be arranged compactly.

In the present embodiment, the pressure pump 43 is arranged in the joining flow path 413. Thus, it is easy to engage the joining flow path 413 in a shape that is efficient and follows the intended path via the pressure pump 43.

Note that the pressure pump 43 may be arranged in the container connecting path 414.

On the other hand, by using a tube with a relatively large thickness, it is possible to reduce oxygen permeability, which is an amount of oxygen that passes through the supply path 41 per unit time. However, it is difficult for a tube with low oxygen permeability to deform. Therefore, it is difficult to arrange a tube with low oxygen permeability compactly in a bent path.

In the present embodiment, the coiled tube 412 is applied to a portion of the supply path 41 that needs to deform in response to movement of the head unit 300.

By employing the ink supply device 4, it is possible to achieve a compact arrangement of the supply path 41 and suppress the generation of air bubbles in the supply path 41 when the head unit 300 is movable.

Various types of experiments have shown that when an amount of dissolved oxygen per 1 [m³] of ink at 32 °C exceeds 0.00512 [m³], which is a saturated dissolved oxygen amount, there is a high possibility that bubbles will form in the ink due to oxygen precipitation.

It is assumed that under typical usage conditions of the inkjet recording apparatus 10, a maximum non-operating time during which ink is not supplied is 12 hours. In this case, it is desirable that oxygen permeability D1 [m³/(m³·h)], which is an amount of oxygen permeated per hour per 1 [m³] of volume of the supply path 41 under an environment of 1 atmosphere (1 [atm]), satisfies Formula (1).

$$\begin{matrix}[ Math 1 ] & \\ D 1 < \frac{( 0.00512 - V 1 )}{12} & ( 1 )\end{matrix}$$

In Formula (1), V1 [m³/m³] is a maximum amount of dissolved oxygen per 1 [m of ink in the ink container 40. When the oxygen permeability D1 [m3/(m3·h)] of the supply path 41 in an environment of 1 atmosphere satisfies Formula (1), the generation of air bubbles in the supply path 41 is suppressed.

For example, in a case in which the maximum amount of dissolved oxygen per 1 [m³] of ink in the ink container 40 is 0.00168 [m³/m³], it is desirable that the oxygen permeability of the supply path 41 in an environment of 1 atmosphere be less than 0.00028 m³/(h·m³).

### Modification

The configuration of the ink supply device 4 described above may be applied to other liquid ejection devices that eject liquids other than ink.

### Supplementary Notes

An outline of the technique according to the disclosure extracted from the above-described embodiments will be added below. Note that the configurations and processing functions described in the following supplementary notes can be selected and combined as desired.

### Supplementary Note 1

A liquid ejection device, including:
a head unit having a liquid ejection head that ejects liquid droplets from each of a plurality of nozzles and that is movably supported; and
a supply path connected to a liquid storage portion that stores liquid and the liquid ejection head, and configured to form a flow path for the liquid to be supplied from the liquid storage portion to the liquid ejection head; wherein
the supply path includes:
a first supply path including a coiled tube that is elastically deformable and is connected to the liquid ejection head; and
a second supply path including a base member made of synthetic resin that forms a groove through which the liquid flows and a joining flow path having a film joined to the base member in a state of closing an opening of the groove; the second supply path being connected to the liquid storage portion and the first supply path.

### Supplementary Note 2

The liquid ejection device according to Supplementary Note 1, wherein
when a maximum amount of dissolved oxygen per 1 [m³] of the liquid in the liquid storage portion is V1 [m³/m³], oxygen permeability D1 [m³/(h·m³)], which is an oxygen permeation amount per hour per 1 [m³] of volume of the supply path, satisfies a Formula (1).

### Supplementary Note 3

The liquid ejection device according to Supplementary Note 1 or 2, including:
a pressure regulation valve device arranged in the first supply path between the coiled tube and the liquid ejection head, and configured to change from a state in which the first supply path is blocked to a state in which the first supply path is released from being blocked in response to a change in pressure within the liquid ejection head when the liquid ejection head ejects the droplets; and
a pressure pump arranged in the joining flow path and configured to pressurize the liquid in the joining flow path; wherein
the head unit includes the pressure regulation valve device.

### Supplementary Note 4

An inkjet recording apparatus, including:
a sheet conveying device configured to convey a sheet; and
a liquid ejection device according to any one of Supplementary Notes 1 to 3 configured to eject ink droplets onto the sheet being conveyed to form an image on the sheet.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A liquid ejection device, comprising:
a head unit having a liquid ejection head that ejects liquid droplets from each of a plurality of nozzles and that is movably supported; and
a supply path connected to a liquid storage portion that stores liquid and the liquid ejection head, and configured to form a flow path for the liquid to be supplied from the liquid storage portion to the liquid ejection head; wherein
the supply path includes:
a first supply path including a coiled tube that is elastically deformable and is connected to the liquid ejection head; and
a second supply path including a base member made of synthetic resin that forms a groove through which the liquid flows and a joining flow path having a film joined to the base member in a state of closing an opening of the groove; the second supply path being connected to the liquid storage portion and the first supply path.

2. The liquid ejection device according to claim 1, wherein
when a maximum amount of dissolved oxygen per 1 [m³] of the liquid in the liquid storage portion is V1 [m³/m³], oxygen permeability D1 [m³/(h·m³)], which is an oxygen permeation amount per hour per 1 [m³] of volume of the supply path, satisfies a Formula (1):
$$\begin{matrix}[ Math 1 ] & \\ D 1 < \frac{( 0.00512 - V 1 )}{12} & ( 1 )\end{matrix}$$

3. The liquid ejection device according to claim 1, comprising:
a pressure regulation valve device arranged in the first supply path between the coiled tube and the liquid ejection head, and configured to change from a state in which the first supply path is blocked to a state in which the first supply path is released from being blocked in response to a change in pressure within the liquid ejection head when the liquid ejection head ejects the droplets; and
a pressure pump arranged in the joining flow path and configured to pressurize the liquid in the joining flow path; wherein
the head unit includes the pressure regulation valve device.

4. An inkjet recording apparatus, comprising:
a sheet conveying device configured to convey a sheet; and
a liquid ejection device according to claim 1 configured to eject ink droplets onto the sheet being conveyed to form an image on the sheet.
